(19) United States
(12) Patent Application Publication
(10) Pub. No.: US 2010/0076729 A1
(43) Pub. Date: Mar. 25, 2010

(54) SELF-DIAGNOSTIC SEMICONDUCTOR EQUIPMENT

(75) Inventors: MATTHEW F. DAVIS, Felton, CA (US); LEI LIAN, Fremont, CA (US); XIAOLIANG ZHUANG, Santa Clara, CA (US); QUENTIN E. WALKER, Fremont, CA (US)

Correspondence Address: MOSER IP LAW GROUP / APPLIED MATERIALS, INC., 1030 BROAD STREET, 2ND FLOOR, SHREWSBURY, NJ, 07702, US

(73) Assignee: APPLIED MATERIALS, INC., Santa Clara, CA (US)

(21) Appl. No.: 12/233,838

(22) Filed: Sep. 19, 2008

(51) Int. Cl. G06F 15/00

(52) U.S. Cl. 702/184

(57) ABSTRACT

Methods and apparatus for predictive maintenance of semiconductor process equipment are provided herein. In some embodiments, a method of performing predictive maintenance on semiconductor processing equipment may include performing at least one self-diagnostic test on the semiconductor processing equipment with no substrate present in the equipment. The self-diagnostic test may include measuring one or more predictor parameters and one or more response parameters from the semiconductor process equipment. One or more expected response parameters may be calculated based upon the measured predictor parameters utilizing a predictive model. The one or more measured response parameters may be compared with the one or more expected response parameters. A determination may be made whether equipment maintenance is required based upon the comparison.

### BACKGROUND

1. Field

Embodiments of the present invention generally relate to semiconductor processing equipment, and, more specifically, to semiconductor processing equipment having predictive maintenance capabilities.

2. Description

Predictive maintenance, as opposed to preventive maintenance, has been the subject of many discussions and conferences in the semiconductor industry. The objective of using data from a processing tool to assess the state of the tool and its need for maintenance has been long pursued. However, the multitude of recipes being used on any given tool, and thus, the amount of effort required to characterize the behavior of the tool over time, presents a huge obstacle to efficiently and effectively implement equipment that suitably meets this objective.

For example, typically, on-wafer performance of the process tool on a frequent basis (for example, every shift) has been utilized in the attempt to continually tune the process tool prior to committing a batch of wafers for processing. However, the effort required to characterize tool behavior as a function of time depending upon the recipes being used and/or the mix of recipes being used presents a prohibitive obstacle to the successful implementation of predictive maintenance.

For example, typically, tool monitoring has involved tracking tool data including RF power, pressure, gas flow, and the like. Unfortunately, tool components such as mass flow controllers, pressure sensors, and the like are individually calibrated. If the calibration is in error or the component is malfunctioning, the tool data can be invalid, and the monitoring of such data may result in a false need for maintenance. Furthermore, in a component such as a mass flow controller, the flow rate is typically monitored at a location removed from the processing volume of the tool (e.g., in the mass flow controller), and thus the monitoring may not be representative of conditions within the processing volume of the tool.

Thus, there is a need for semiconductor equipment having effective predictive maintenance capabilities.

### SUMMARY

Methods and apparatus for predictive maintenance of semiconductor process equipment are provided herein. In some embodiments, a method of performing predictive maintenance on semiconductor processing equipment may include performing at least one self-diagnostic test on the semiconductor processing equipment with no substrate present in the equipment. The self-diagnostic test may include measuring one or more predictor parameters and one or more response parameters from the semiconductor process equipment. One or more expected response parameters may be calculated based upon the measured predictor parameters utilizing a predictive model. The one or more measured response parameters may be compared with the one or more expected response parameters. A determination may be made whether equipment maintenance is required based upon the comparison. Other and further variations and embodiments are disclosed in the detailed description, below.

In some embodiments, a computer readable medium may be provided having instructions stored thereon that, when executed by a processor, cause the processor to perform a method for predictive maintenance of semiconductor process equipment, including: performing at least one self-diagnostic test on the semiconductor processing equipment with no substrate present in the equipment. The self-diagnostic test may be the same as discussed above.

In some aspects of the invention a system for processing semiconductor substrates is provided. In some embodiments, a system for processing semiconductor substrates may include a process chamber and a controller coupled to the process chamber and configured to control the operation thereof. The controller includes computer readable medium having instructions stored thereon that, when executed by the controller, cause the controller to perform a method for predictive maintenance of the process chamber. The method of performing predictive maintenance on semiconductor processing equipment may be the same as discussed above.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a flow chart depicting a process for performing predictive maintenance in accordance with some embodiments of the invention.

FIG. 2 is a flow chart depicting a process for performing self-diagnostic testing in accordance with some embodiments of the invention.

FIG. 3 depicts an etch chamber suitable for use in connection with some embodiments of the invention; and

FIG. 4 depicts a schematic diagram of an exemplary integrated semiconductor substrate processing system (e.g., cluster tool) of the kind suitable for use in connection with some embodiments of the invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention provide apparatus capable of performing predictive maintenance and methods for performing predictive maintenance on the apparatus. The apparatus may be any suitable processing apparatus as described in more detail below, such as semiconductor processing equipment. The method may be stored in the memory of a controller configured to control the apparatus. The methods and apparatus of the present invention facilitate the implementation of predictive maintenance in a manageable fashion by using a limited number (one or more) of waferless (or substrate-less) recipes or other instructions to help capture the overall tool dynamics and characterize tool performance over time. The characterized tool performance may be compared to a baseline characterization for a particular tool to determine whether maintenance is required. The recipe(s), or instructions, can be ran automatically (e.g., invoked by the tool) and/or ran manually (e.g., invoked by the operator).

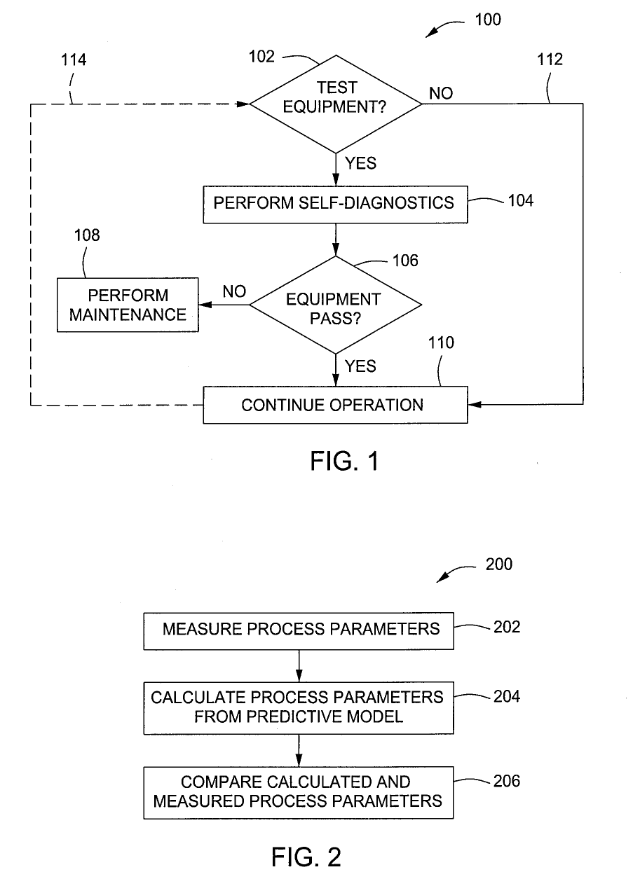

FIG. 1 is a flow chart depicting a predictive maintenance process 100 in accordance with some embodiments of the present invention. The process 100 may be stored in memory of a controller of one or more pieces of process equipment (such as a process chamber as discussed below). The process 100 begins at 102, where a decision may be made regarding whether or not to test the equipment. The decision to test the equipment may be made at any desired stage of the semiconductor manufacturing process, such as based upon actual time elapsed between checks, equipment runtime elapsed, prior to introducing the first wafer (or substrate) into the equipment, between processing each wafer in the equipment, between processing wafer lots in the equipment, shift-to-shift changes of operators, between making changes in the process conditions in the equipment, after chamber clean processes or other maintenance of the equipment, or at any other time deemed desirable. The decision at 102 may be made automatically (e.g., invoked by the tool) and/or manually (e.g., invoked by the operator) at any suitable or desirable time, such as during equipment idle time.

If a decision is made not to test the equipment, the equipment may continue operation as shown by line 112 leading to block 110. The equipment may continue to operate until the query of whether to test the equipment is made (as shown by dashed line 114 leading back to decision block 102). If a decision is made to test the equipment, a self-diagnostic test may be performed on the equipment (as depicted at 104).

The self-diagnostic test utilizes a waterless (or substrate-less) self-diagnostic process recipe that does a perturbation test to each individual process parameter of interest (as discussed below). The self-diagnostic process recipe requires no wafer (nor substrate) in the chamber and thus eliminates any wafer-or substrate-related effects in the chamber response. Such a recipe also provides the health check of multiple critical hardware components on the chamber through one run and, thus, is very efficient.

The self-diagnostic test may include monitoring of process parameters including predictor and response parameters. The predictor parameters may include any parameter that can be directly and/or independently measured. Examples of suitable predictor parameters may include tool status variable identifiers (SVIDs) such as RF bias voltage, RF bias current, wafer self bias potential (V_{dc}), throttle valve angle, total flow, electrostatic chuck (ESC) current, or the like, optical emissions, infrared absorption or transmittance of process gases within the process chamber, or the like. As such, the predictor parameters may be utilized as an independent confirmation of chamber performance.

The response parameters may include any parameter obtained from a chamber component that is individually calibrated and directly associated with the equipment (e.g., the response parameter may be a readback value from a control element or module coupled to the process chamber). The response parameters may be obtained from a sensor coupled to a chamber component, and/or may be a setpoint from a controller that controls the chamber component. In some embodiments, the response parameters may include one or more of a chamber or component temperature (such as the temperature of a substrate support pedestal, electrostatic chuck, or the like), an RF power delivered to the chamber (such as an RF source power or an RF bias power), RF harmonics, an electrical signal (such as a voltage, a current, a phase interaction, or the like), a gas flow rate of a gas introduced into the equipment (such as through a mass flow controller or the like), a pressure of an internal process volume of the equipment, or the like. In some embodiments, the response parameters may be obtained by recording sensor data (such as thermocouples, pressure sensors, electrical sensors, or the like). In some embodiments, a value of the response parameter may be directly obtained from a programmed setpoint of an individual component.

When a self-diagnostic test begins, a self-diagnostic process recipe may be performed in the process chamber. The self-diagnostic process recipe may systematically test one or more process parameters. In some embodiments, the self-diagnostic process recipe may include perturbing one or more response parameters and measuring one or more predictor parameters. In some embodiments, predictor parameters may be obtained by performing a perturbation test to each individual response parameter of interest. For example, in some embodiments, a response parameter such as RF source power may be perturbed slightly (e.g., from 1000 Watts to 1100 Watts) holding all other response parameters constant and measuring the change in the predictor parameters. Each response parameter may be perturbed in a similar manner until a test matrix including perturbations of each individual response parameter is generated. The test matrix may be utilized in a predictive model as described below.

The self-diagnostic tests may be performed at 104 in a variety of ways. For example, FIG. 2 depicts a flow chart of a process 200 for performing self-diagnostic tests in accordance with some embodiments of the invention. The process 200, and variants thereof, may be utilized as at least a part of the self diagnostic test described with respect to FIG. 1 at 104. In some embodiments, the self-diagnostic measurements may be performed by measuring process parameters as described above in accordance with a self-diagnostic process recipe (as shown at 202). The self-diagnostic process recipe may be introduced, for example, as part of instructions stored in the memory of the controller of the equipment, or manually input by the operator. The self-diagnostic process recipe may be unique to the type of process chamber being tested, and may include the perturbation of one or more response parameters that may be unique to the chamber being tested. For example, in a plasma process chamber the self-diagnostic process recipe may comprise perturbing one or more of RF power, RF bias, chamber pressure, gas flow rate, and the like, and measuring optical emissions, or the like from a plasma generated at conditions specified in the self-diagnostic process recipe. The self-diagnostic process recipe may perturb one or more of the response parameters sequentially, concurrently, or the like, and may measure one or more predictor parameters at each perturbation.

In some embodiments, the self-diagnostic process recipe may be executed when there is no wafer present in the equipment, thereby reducing dependence upon production wafers or test wafers for the analysis of chamber performance. Eliminating the presence of the wafer also may reduce the time required for performing the test, the test variance introduced by varying wafer compositions, the risk of damage to production wafers if used, and the like.

Next, at 204, the process parameters may be calculated using a predictive model. The predictive model may be generated using a suitable statistical analysis, such as a partial least squares (PLS) regression analysis, as discussed further below. In some embodiments, the one or more measured predictor parameters may be used as input data for the predictive model. Using the one or more measured predictor parameters, facilitates generation of a predictive model that may more accurately calculate a value of each response parameter. The calculated values of the response parameters may be the same as, or may differ from the values obtained from the sensor data and/or the setpoint value.

The predictive model may be formulated using a baseline characterization of the equipment. The baseline characterization may include one or more measurements and/or analysis of the performance of equipment that is known or presumed to be in acceptable or optimized condition, one or more modeled measurements of equipment designated as ideal (e.g., a “golden chamber”), or combinations thereof, or the like. For example, in some embodiments, the baseline characterization may be performed using the self-diagnostic process recipe discussed above in a chamber operating under ideal conditions. The self-diagnostic process recipe may be run and predictor parameters and response parameters measured and/or obtained at each perturbation step to generate a test matrix containing the predictor parameters and the response parameters. At each perturbation, the measurements of the one or more predictor parameters and the sensor data (or setpoint data) of each response parameter may be recorded into a test matrix. The test matrix may comprise the one or more measured predictor parameters and the sensor data or setpoint data of each individual response parameter from all perturbation steps in the self-diagnostic process recipe.

The test matrix formed from the application of the self-diagnostic process recipe to a process chamber operating under optimized conditions can be regressed using, for example, a PLS regression analysis to generate a predictive model. One predictive model may be created for multiple response parameters by regressing the predictor matrix and response matrix collected from the self-diagnostic calibration run (e.g., making the predicted values equal to the measured tool data during the initial characterization or model of the golden/ideal chamber). In some embodiments, the predictive model can also be applied to different chambers to provide a precision chamber matching solution.

The predictive model may be capable of predicting and/or calculating the response parameters at any chamber conditions, and may not be limited to those chamber conditions utilized in the test recipe. In some embodiments, the predictive model uses one or more measured predictor parameters as an input for predicting/calculating one or more response parameters. By utilizing a designed experiment based on a production process, a predictive model can be generated to monitor production process drift and provide fault detection.

In some embodiments, the predictive model may generated utilizing a calibration process, a validation process, and, if needed, a modification and revalidation process. In the calibration process, both the response parameters and the predictor parameters are collected through a design of experiment as discussed above. The predictive model may be created based on such data using, for example, partial least squares regression. The predictive model then takes the predictor parameters as input and calculates the values of the response parameters as output.

Next, the validation process utilizes another set of response parameters and predictor parameters. The predictor parameters are used as input to the predictive model and the response parameters are used to compare with the output of the predictive model. If the difference between the predicted value and the actual value of the response parameters exceeds a user defined limit, then the predictive model has to be modified. If the predicted values of the response parameters are close enough to their real value, then the predictive model is ready to be used to in production.

Next, at 206, the calculated process parameters may be compared with the measured process parameters obtained at the onset of the self-diagnostic test at 202. In some embodiments, observed response parameters may be compared with calculated response parameters, and the difference, percentage difference, a statistical analysis thereof, or the like may be computed. In some embodiments, a variation between the observed and calculated response parameters of each individual chamber component may be computed, and a determination may be made regarding which component, or combination of chamber components may be out of calibration, damaged, require maintenance, cleaning, or the like.

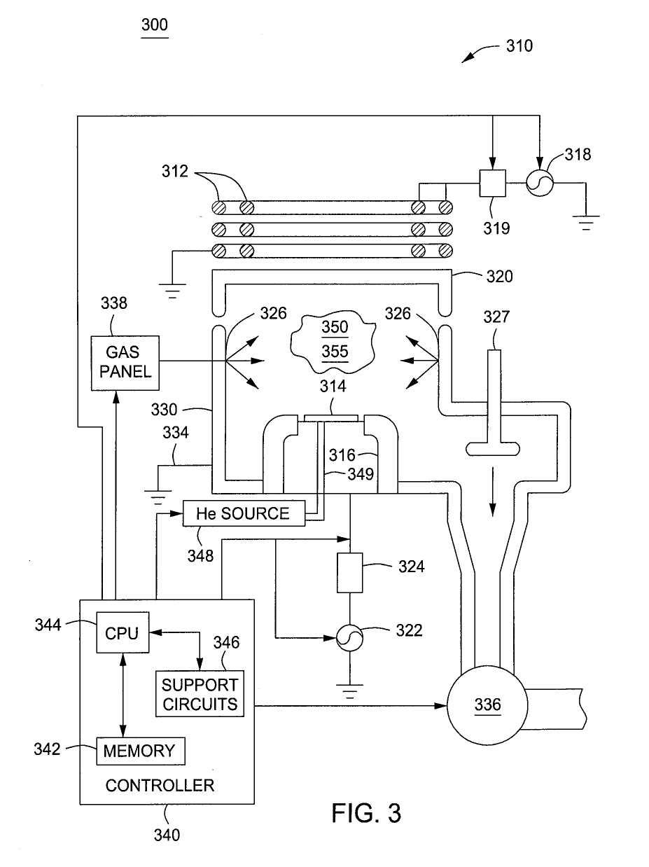

The comparison performed at 206 may be real-time. Comparing the predicted values of the response parameters with monitored/observed tool data provides a self-consistency check for the chamber. If these two does not agree, a fault specific to the parameter that does not pass the self consistency check may be generated in situ to warn the user. For example, the self-diagnostic test can be implemented by importing tool sensor data from the tool to a controller that performs the statistical analysis and applies the predictive model during run time. In some embodiments, the controller may be part of the EYED® PSM system installed on etch tools available from Applied Materials, Inc., of Santa Clara, Calif. (such as described below with respect to FIG. 3). Since the EYED® system also has endpoint capability, it can easily be used to intervene with the process and raise warning or fault message when it detects an abnormal condition during the self diagnostic runs.

Returning to FIG. 1, after the self diagnostics are performed at 104 (or the process 200 for performing self-diagnostic tests), a decision may be made as to whether the equipment passes the self-diagnostic test (as depicted at 106). If the answer is yes, the equipment may continue operation, as depicted at 110 until the query to test equipment is invoked again at 102 (as depicted by dashed line 114). For example, if the analysis of the self-diagnostic measurement is within a specified tolerance range of a baseline measurement (e.g., the variation between the calculated response parameter and observed response parameter is with a specified tolerance range), then the equipment may continue to operate without stopping for maintenance.

If the equipment fails to pass the test (e.g., the answer to the query at 106 is no), maintenance may be performed on the equipment, as depicted at 108. For example, if the analysis of the self-diagnostic measurement falls outside of the tolerance range, then operation of the equipment may be suspended, and maintenance may be performed to return the equipment to satisfactory operating condition. Maintenance may include in situ cleaning of the equipment, adjustment, repair, or replacement of equipment components, or the like. After maintenance of the equipment is complete, the process 100 may be repeated as desired to insure that the equipment is operating satisfactorily.

The above self-diagnostic processes may be performed manually or automatically and may be repeated or invoked at the time frames or stages of production as described above. The inventive self-diagnostic processes may be implemented in any semiconductor fabrication equipment, including (in a non-limiting example) plasma and non-plasma assisted equipment, magnetically enhanced processing equipment, thermal processing equipment, etch chambers, deposition chambers, thermal processing chambers (e.g., annealing chambers), or the like.

For example, FIG. 3 depicts a schematic diagram of an exemplary etch reactor 300 of the kind that may be used to practice embodiments of the invention as discussed herein. The reactor 300 may be utilized alone or, more typically, as a processing module of an integrated semiconductor substrate processing system, or cluster tool, such as a CENTURA® integrated semiconductor wafer processing system, available from Applied Materials, Inc. of Santa Clara, Calif. Examples of suitable etch reactors 300 include the DPS® line of semiconductor equipment (such as the DPS®, DPS® II, DPS® AE, DPS® G3 poly etcher, or the like), the ADVANTEDGE™ line of semiconductor equipment (such as the AdvantEdge, AdvantEdge G3), or other semiconductor equipment (such as ENABLER®, E-MAX®, or like equipment), also available from Applied Materials, Inc. The above listing of semiconductor equipment is illustrative only, and other etch reactors, and non-etch equipment (such as CVD reactors, or other semiconductor processing equipment) may suitably be used as well.

The reactor 300 comprises a process chamber 310 having a wafer support pedestal 316 within a conductive body (wall) 330, and a controller 340. The support pedestal (cathode) 316 is coupled, through a first matching network 324, to a biasing power source 322. The biasing source 322 generally is a source of up to 500 W at a frequency of approximately 13.56 MHz that is capable of producing either continuous or pulsed power. In other embodiments, the source 322 may be a DC or pulsed DC source. The chamber 310 is supplied with a substantially flat dielectric ceiling 320. Other modifications of the chamber 310 may have other types of ceilings such as, for example, a dome-shaped ceiling or other shapes. At least one inductive coil antenna 312 is disposed above the ceiling 320 (two co-axial antennas 312 are shown in FIG. 3). Each antenna 312 is coupled, through a second matching network 319, to a plasma power source 318. The plasma source 318 typically is capable of producing up to 4000 W at a tunable frequency in a range from 50 kHz to 13.56 MHz. Typically, the wall 330 may be coupled to an electrical ground 334.

During a typical operation, a semiconductor substrate, or wafer 314 may be placed on the pedestal 316 and process gases are supplied from a gas panel 338 through entry ports 326 and form a gaseous mixture 350. The gaseous mixture 350 is ignited into a plasma 355 in the chamber 310 by applying power from the plasma source 318 to the antenna 312. Optionally, power from the bias source 322 may be also provided to the cathode 316. The pressure within the interior of the chamber 310 is controlled using a throttle valve 327 and a vacuum pump 336. The temperature of the chamber wall 330 is controlled using liquid-containing conduits (not shown) that run through the wall 330.

The temperature of the wafer 314 may be controlled by stabilizing a temperature of the support pedestal 316. In one embodiment, the helium gas from a gas source 348 is provided via a gas conduit 349 to channels formed by the back of the wafer 314 and grooves (not shown) in the pedestal surface. The helium gas is used to facilitate heat transfer between the pedestal 316 and the wafer 314. During the processing, the pedestal 316 may be heated by a resistive heater (not shown) within the pedestal to a steady state temperature and then the helium gas facilitates uniform heating of the wafer 314. Using such thermal control, the wafer 314 may be maintained at a temperature of between 0 and 500 degrees Celsius.

Those skilled in the art will understand that other forms of etch chambers may be modified in accordance with the teachings disclosed herein, including chambers with remote plasma sources, microwave plasma chambers, electron cyclotron resonance (ECR) plasma chambers, and the like.

The controller 340 comprises a central processing unit (CPU) 344, a memory 342, and support circuits 346 for the CPU 344 and facilitates control of the components of the etch process chamber 310 and, as such, of etch processes, such as discussed herein. The controller 340 may be one of any form of general-purpose computer processor that can be used in an industrial setting for controlling various chambers and sub-processors. The memory, or computer-readable medium, 342 of the CPU 344 may be one or more of readily available memory such as random access memory (RAM), read only memory (ROM), floppy disk, hard disk, or any other form of digital storage, local or remote. The support circuits 346 are coupled to the CPU 344 for supporting the processor in a conventional manner. These circuits include cache, power supplies, clock circuits, input/output circuitry and subsystems, and the like. The inventive method may be stored in the memory 342 as software routine and may be executed or invoked in the manner described above. The software routine may also be stored and/or executed by a second CPU (not shown) that is remotely located from the hardware being controlled by the CPU 344.

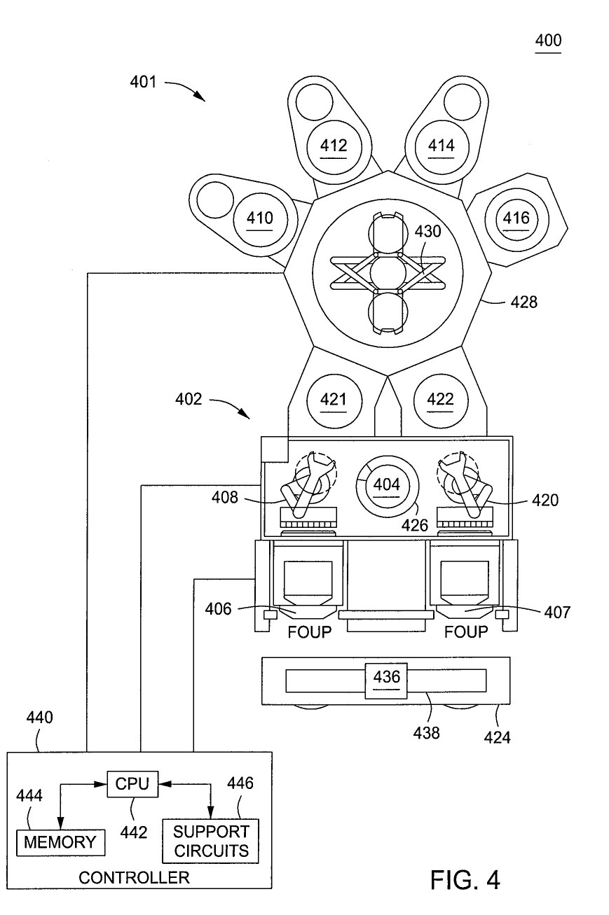

FIG. 4 depicts a schematic diagram of an exemplary integrated semiconductor substrate processing system (e.g., cluster tool) 400 of the kind used in one embodiment of the invention.

The system 400 illustratively includes a vacuum-tight processing platform 401, an input/output module 402, and a system controller 440. In one embodiment, the platform 401 comprises processing modules 410, 412, 414 and 416 and at least one load-lock chamber (load-lock chambers 421 and 422 are shown), which are coupled to a common vacuumed substrate transfer chamber 428.

The processing modules 410, 412, 414 and 416 may be any semiconductor processing module suitable for practicing the present invention including the semiconductor processing equipment described above.

The load-lock chambers 421 and 422 protect the transfer chamber 428 from atmospheric contaminants. The transfer chamber 428 comprises a substrate robot 430. In operation, the robot 430 transfers the substrates between the load lock chambers and processing modules. The depicted embodiment of the robot 430 is illustrative only.

The input/output module 402 comprises a metrology module 426, at least one docking station to accept one or more front opening unified pod (FOUP) (FOUPs 406 and 407 are shown) and at least one substrate robot (two robots 408 and 420 are shown). In one embodiment, the metrology module 426 comprises a measuring tool 404 employing at least one non-destructive measuring technique suitable for measuring critical dimensions of structures formed on the substrate. One suitable measuring tool 404 that optically measures critical dimensions is available from Nanometrics, located in Milpitas, Calif. The robots 408 and 420 transfer the pre-processed and post-processed substrates between the FOUPs 406, measuring tool 404, and load-lock chambers 421, 422. In the depicted embodiment, the metrology module 426 is used as a pass-through module. In other embodiments (not shown), the metrology module 426 may be a peripheral unit of the input/output module 402. The processing system having a measuring tool is disclosed, for example, in commonly assigned U.S. Pat. No. 6,150,664, issued Nov. 21, 2000, which is incorporated herein by reference.

The factory interface 424 is generally an atmospheric pressure interface used to transfer the cassettes with pre-processed and post-processed wafers disposed in the FOUPs 406, 407 between various processing systems and manufacturing regions of the semiconductor fab. Generally, the factory interface 424 comprises a substrate-handling device 436 and a track 438. In operation, the substrate-handling device 436 travels along the track 438 to transport the FOUPs between cluster tools or other processing equipment.

The system controller 440 is coupled to and controls modules and apparatus of the integrated processing system 400. The system controller 440 controls all aspects of operation of the system 400 using a direct control of modules and apparatus of the system 400 or, alternatively, by controlling the computers (or controllers) associated with these modules and apparatus. In operation, the system controller 440 enables data collection and feedback from the respective modules (e.g., metrology module 426) and apparatus that optimizes performance of the system 400.

The system controller 440 generally comprises a central processing unit (CPU) 442, a memory 444, and support circuits 446. The CPU 442 may be one of any form of a general purpose computer processor that can be used in an industrial setting. The support circuits 446 are conventionally coupled to the CPU 442 and may comprise cache, clock circuits, input/output subsystems, power supplies, and the like. The software routines, when executed by the CPU 442, transform the CPU into a specific purpose computer (controller) 440. The software routines may also be stored and/or executed by a second controller (not shown) that is located remotely from the system 400.

Embodiments of the inventive method described above may be stored in the memory 444 as software routine. The software routine may also be stored and/or executed by a second CPU (not shown) that is remotely located from the hardware being controlled by the CPU 442. In operation, the controller 440 may issue instructions to perform the inventive methods to the system 400 directly, or alternatively, via other computers or controllers (not shown) associated with the process chambers 410-416 and/or their support systems. Alternatively, as described above, the inventive methods may be contained on the controllers associated with the process chambers 410-416.

Thus, methods for performing predictive maintenance of semiconductor process equipment and self-aware semiconductor equipment adapted for performing the same have been provided herein. The methods may advantageously be performed on semiconductor equipment without a wafer being present. The methods may be used to assess whether the equipment is behaving erratically and requires maintenance or its behavior is predictable and thus ready for wafer processing. Embodiments of the present invention provide a means to assess the health of semiconductor equipment and guage the health of the tool, for example, within its life-cycle between cleaning operations. By factoring out wafer and recipe dependence on creating chamber “golden” signatures, and by independently monitoring the equipment by optical emission or the like, the accuracy of fault detection may be improved dramatically. Moreover, the teachings of the present invention may be implemented in a non-customer/fab dependent manner, thereby facilitating uniform and reduced-cost implementation of such self-aware equipment and predictive maintenance technologies.

While the foregoing is directed to embodiments of the present invention, other and further embodiments of the invention may be devised without departing from the basic scope thereof, and the scope thereof is determined by the claims that follow.

1. A method of performing predictive maintenance on semiconductor processing equipment, comprising:
performing at least one self-diagnostic test on the semiconductor processing equipment with no substrate present in the equipment, the self-diagnostic test comprising:
measuring one or more predictor parameters and one or more response parameters from the semiconductor process equipment;
calculating one or more expected response parameters based upon the measured predictor parameters utilizing a predictive model;
comparing the one or more measured response parameters with the one or more expected response parameters; and
determining whether equipment maintenance is required based upon the comparison.

2. The method of claim 1, wherein the predictive model is generated by:
measuring predictor parameters and response parameters from the semiconductor process equipment with no substrate present when the equipment is operating at an optimized level; and
statistically analyzing the measured parameters to generate the predictive model.

3. The method of claim 1, wherein the predictor parameters comprise at least one of tool status variable identifiers (SVIDs), RF bias voltage, RF bias current, wafer self bias potential (V_{dc}), throttle valve angle, total flow, electrostatic chuck (ESC) current, optical emission data, or infrared radiation data,.

4. The method of claim 1, wherein the response parameters comprise at least one of a temperature of a substrate support pedestal or an electrostatic chuck, delivered RF power of an RF source power or an RF bias power, a gas flow rate of one or more gases introduced into the equipment, or process volume pressure.

5. The method of claim 1, wherein the at least one self-diagnostic test is performed during equipment idle time.

6. The method of claim 1, wherein the at least one self-diagnostic test is performed periodically based upon at least one of actual time elapsed between checks, equipment runtime elapsed, prior to introducing the first wafer into the equipment, between processing each wafer in the equipment, between processing wafer lots in the equipment, shift-to-shift changes of operators, between making changes in the process conditions in the equipment, or after chamber clean processes or other maintenance of the equipment.

7. The method of claim 1, wherein the equipment invokes the at least one self-diagnostic test automatically.

8. The method of claim 1, wherein measuring one or more predictor parameters and one or more response parameters from the semiconductor process equipment further comprises:
invoking a self-diagnostic test recipe that perturbs the one or more predictor parameters and measures the one or more response parameters.

9. The method of claim 1, further comprising:
generating a warning in response to a determination that equipment maintenance is required.

10. A computer readable medium having instructions stored thereon that, when executed by a processor, cause the processor to perform a method for predictive maintenance of semiconductor process equipment, comprising:
performing at least one self-diagnostic test on the semiconductor processing equipment with no substrate present in the equipment, the self-diagnostic test comprising:
measuring one or more predictor parameters and one or more response parameters from the semiconductor process equipment;
calculating one or more expected response parameters based upon the measured predictor parameters utilizing a predictive model;
comparing the one or more measured response parameters with the one or more expected response parameters;
determining whether equipment maintenance is required based upon the comparison.

11. The computer readable medium of claim 10, wherein the predictive model is generated by:
measuring predictor parameters and response parameters from the semiconductor process equipment with no substrate present when the equipment is operating at an optimized level; and
statistically analyzing the measured parameters to generate the predictive model.

12. The computer readable medium of claim 10, wherein the predictor parameters comprise at least one of tool status variable identifiers (SVIDs), RF bias voltage, RF bias current, wafer self bias potential (V_{dc}), throttle valve angle, total flow, electrostatic chuck (ESC) current, optical emission data, or infrared radiation data.

13. The computer readable medium of claim 10, wherein the response parameters comprise at least one of a temperature of a substrate support pedestal or an electrostatic chuck, delivered RF power of an RF source power or an RF bias power, a gas flow rate of one or more gases introduced into the equipment, or process volume pressure.

14. The computer readable medium of claim 10, wherein the equipment invokes the at least one self-diagnostic test automatically.

15. The computer readable medium of claim 10, wherein measuring one or more predictor parameters and one or more response parameters from the semiconductor process equipment further comprises:
invoking a self-diagnostic test recipe that perturbs the one or more predictor parameters and measures the one or more response parameters.

16. The computer readable medium of claim 10, further comprising:
generating a warning in response to a determination that equipment maintenance is required.

17. A system for processing semiconductor substrates, comprising:
a process chamber; and
a controller coupled to the process chamber and configured to control the operation thereof, wherein the controller comprises computer readable medium having instructions stored thereon that, when executed by the controller, cause the controller to perform a method for predictive maintenance of the process chamber, comprising:
performing at least one self-diagnostic test on the semiconductor processing equipment with no substrate present in the equipment, the self-diagnostic test comprising:
measuring one or more predictor parameters and one or more response parameters from the semiconductor process equipment;
calculating one or more expected response parameters based upon the measured predictor parameters utilizing a predictive model;
comparing the one or more measured response parameters with the one or more expected response parameters; and
determining whether equipment maintenance is required based upon the comparison.

18. The system of claim 17, wherein the predictive model is generated by:
measuring predictor parameters and response parameters from the semiconductor process equipment with no substrate present when the equipment is operating at an optimized level; and
statistically analyzing the measured parameters to generate the predictive model.

19. The system of claim 17, wherein the predictor parameters comprise at least one of tool status variable identifiers (SVIDs), RF bias voltage, RF bias current, wafer self bias potential (V_{dc}) throttle valve angle, total flow, electrostatic chuck (ESC) current, optical emission data, or infrared radiation data,.

20. The system of claim 17, wherein the response parameters comprise at least one of a temperature of a substrate support pedestal or an electrostatic chuck, delivered RF power of an RF source power or an RF bias power, a gas flow rate of one or more gases introduced into the equipment, or process volume pressure.

21. The system of claim 17, wherein the equipment invokes the at least one self-diagnostic test automatically.

22. The system of claim 17, wherein measuring one or more predictor parameters and one or more response parameters from the semiconductor process equipment further comprises:
invoking a self-diagnostic test recipe that perturbs the one or more predictor parameters and measures the one or more response parameters.

23. The system of claim 17, further comprising:
generating a warning in response to a determination that equipment maintenance is required.
